(19) United States
(12) Patent Application Publication
(10) Pub. No.: US 2026/0130825 A1
(43) Pub. Date: May 14, 2026

(54) Massager Handle

(71) Applicant: Dongguan Yixu Technology Co., Ltd, Dongguan City (CN)

(72) Inventor: Xudong Li, Dongguan City (CN)

(21) Appl. No.: 18/945,464

(22) Filed: Nov. 12, 2024

(51) Int. Cl. A61H 37/00

(52) U.S. Cl. CPC A61H 37/00; A61H 2201/0153

(57) ABSTRACT

A massager handle includes a clamping handle on an outside portion of a massager such as a masturbation cup and includes an upper shell, a lower shell, a clamping ring, a button, a battery, a charging base, a PCB board, and an anti-skid pad; the lower shell is provided on both sides of the clamping ring, and the upper shell is connected to the upper part of the lower shell to form a handle; the battery, the charging base and the PCB board are installed in the handle, the array buttons are provided on the handle to form a remote control handle, the anti-skid pad is provided on the inner side of the clamping ring, and tightening strips are connected to both ends of the clamping ring.

### FIELD OF THE INVENTION

The invention relates to the technical field of clamping handles, and in particular to the improvement of massager handles.

### BACKGROUND OF THE INVENTION

In daily life, people's pace of life is accelerating and the pressure is increasing day by day, so people's demand for decompression is getting stronger and stronger. At the same time, with the diversified development of social thoughts, adult health care products are becoming more and more accepted by people, such as masturbation cups.

When using the massagers of prior arts, users often feel uncomfortable holding the massagers or feel hand fatigue after use due to unreasonable designs.

### SUMMARY OF THE DISCLOSURE

In view of the shortcomings of the prior art, the present invention provides a massager handle, detachable and adjustable provided on the massagers of different sizes, which conforms to the gripping curvature of the human palm, enhances the gripping comfort, and ensures the stability of use through an anti-slip design, thereby solving the problem of hand fatigue or discomfort that may occur after using the massager for a while.

To achieve the above object, the present invention provides a message handle having a gripping arc that conforms to the palm of a human body, enhancing gripping comfort, and ensuring use stability through an anti-slip design, the technical solutions adopted by the present invention are as follows:

A massager handle includes a massager and a clamping handle, wherein the clamping handle is provided on the outside of a massager such as a masturbation cup, and comprises an upper shell, a lower shell, a clamping ring, a button, a battery, a charging base, a PCB board, and an anti-skid pad; the lower shell is provided on both sides of the clamping ring, the upper shell is connected to the upper part of the lower shell to form a handle; the battery, the charging base and the PCB board are installed in the handle, the array buttons are provided on the handle, the anti-skid pad is provided on the inner side of the clamping ring, and the clamping ring is connected with a tightening strip.

Furthermore, the upper shell and the lower shell are made of plastic or silicone.

Furthermore, the battery, charging base, PCB board are control connected to the massager.

Furthermore, the battery is any one of a rechargeable battery, a lithium battery or a dry cell.

Furthermore, the charging base is provided as TPC interface, and the charging base is connected with a charging electronic connection line.

Furthermore, the PCB board is made of FR material board.

Furthermore, the anti-skid pad is made of a high-friction anti-skid material, and anti-skid patterns are provided on one end of the anti-skid pad close to the massager.

Furthermore, the handle is provided as an angle-adjustable handle, and the handle is turnably connected to both sides of the clamping ring.

Furthermore, the handle is provided as a remote control handle, and the control method is infrared remote control or Bluetooth control.

Compared with the prior art, the present invention provides a massager handle having the following beneficial effects:

It not only improves the grip comfort and user experience of the massager, but also brings users convenient operation and better interactive experience through intelligent design. Its ergonomic design, combined with intelligent control functions, makes it an important supporting equipment for massagers such as masturbation cups.

### BRIEF DESCRIPTION OF THE DRAWINGS

FIG. 1 is a schematic structural view of the present invention.

FIG. 2 is an exploded view of the clamping handle of the present invention.

FIG. 3 is a front view of the clamping handle of the present invention.

FIG. 4 is a bottom view of the FIG. 3.

FIG. 5 is a first side view of the clamping handle.

FIG. 6 is a second side view of the clamping handle.

FIG. 7 is a bottom view of the FIG. 1.

FIG. 8 is a schematic structural view of the clamping handle of the present invention.

FIG. 9 is a schematic structural view of the clamping handle in Embodiment 2.

FIG. 10 is a schematic structural view of the handle in Example 3.

FIG. 11 is a first schematic view of the rotation method of the handle in Embodiment 3.

FIG. 12 is a second schematic view of the rotation method of the handle in the Embodiment 3.

### DETAILED DESCRIPTION OF THE PREFERRED EMBODIMENTS

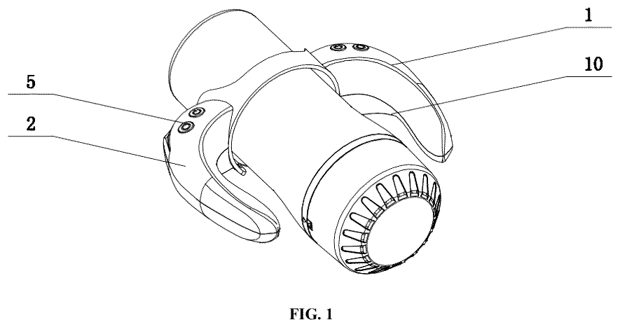

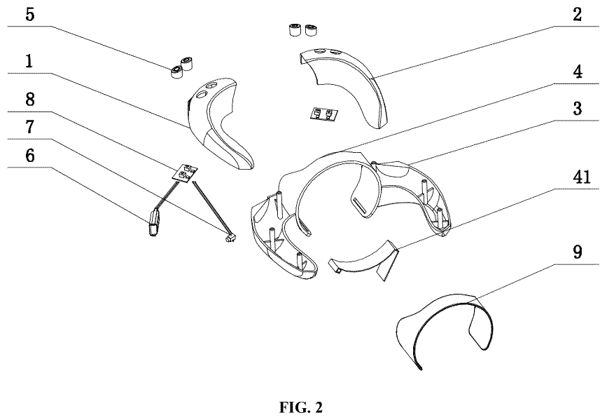

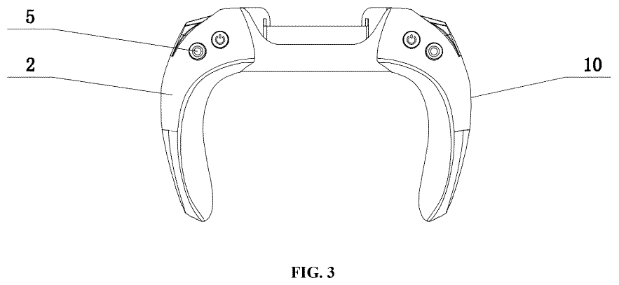

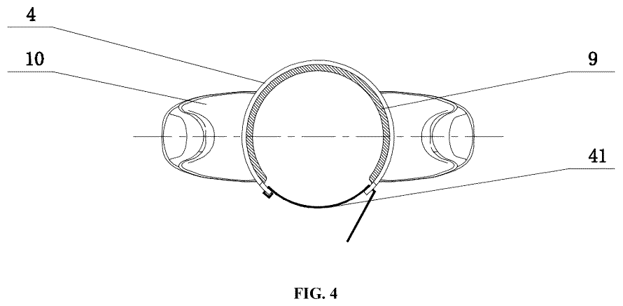

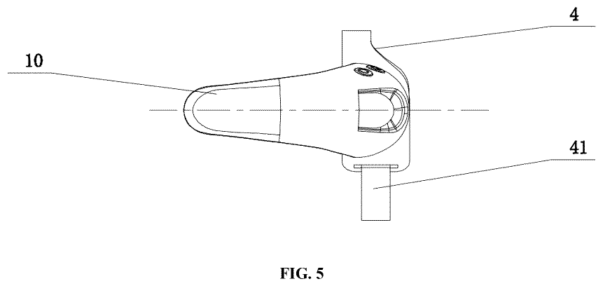

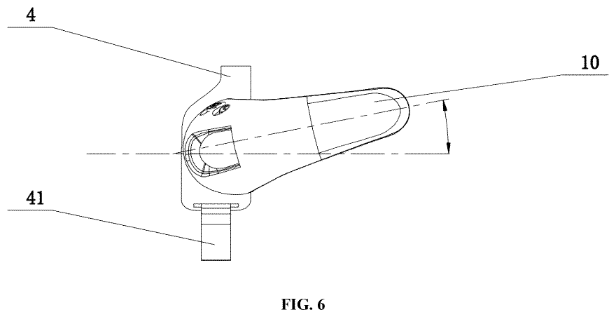

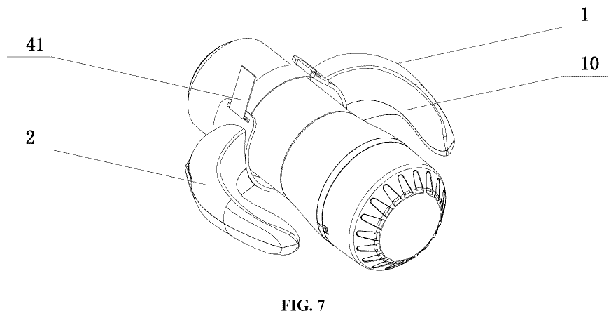

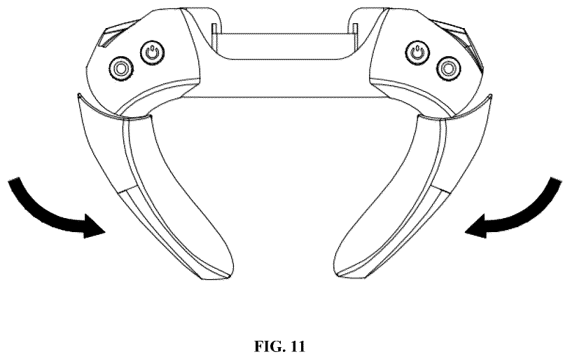

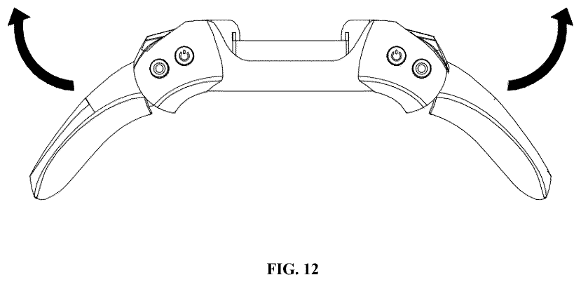

Other features, objects and advantages of the present invention will be more clearly and completely by the detailed description of the non-limiting embodiments with reference to the attached drawings (FIG. 1 to FIG. 12). Obviously, the described embodiments are only part of the embodiments of the present invention, but not all of them. Based on the embodiments of the present invention, all other embodiments obtained by ordinary technicians in the field without creative labor are within the protection scope of the present invention. Components in the figures are not drawn to scale, and similar reference numbers are generally used to describe similar components.

### Embodiment 1

As shown in FIGS. 1 to 7, a massager handle according to the first embodiment of the present invention includes a massager and a clamping handle 1, wherein the clamping handle 1 is provided on the outside of a massager such as a masturbation cup and comprises an upper shell 2, a lower shell 3, a clamping ring 4, a button 5, a battery 6, a charging base 7, a PCB board 8, and an anti-slip pad 9; the lower shell 3 is provided on both sides of the clamping ring 4, the upper shell 2 is connected to the upper part of the lower shell 3 and forms a handle 10; the battery 6, the charging base 7 and the PCB board 8 are installed in the handle 10, the array buttons 5 are provided on the handle 10, the anti-slip pad 9 is provided on the inner side of the clamping ring 4, and the clamping ring 4 is connected with a tightening strip 41.

As shown in FIGS. 1 to 7, the upper shell 2 and the lower shell 3 are made of plastic or silicone, which is light and easy to hold.

As shown in FIGS. 1-7, the battery 6, charging base 7, and PCB board 8 are control connected to the massager. The battery 6 and the charging base 7 provide power for the massager, the PCB board 8 is used to control the operation mode of the massager, and the buttons 5 are provided on the surface of the upper shell 2 for easy operation.

As shown in FIGS. 1-7, the battery 6 is any one of a rechargeable battery, a lithium battery or a dry cell, which is convenient for users to use for a long time.

As shown in FIGS. 1-7, the charging base 7 is provided as TPC interface, and the charging base 7 is connected with a charging electronic connection line, which is used to control the operation mode of the massager.

As shown in FIGS. 1-7, the PCB board 8 is made of FR4 material board.

As shown in FIGS. 1-7, the anti-skid pad 9 is made of high-friction anti-skid material, and anti-skid patterns are provided at one end of the anti-skid pad close to the massager, so as to ensure that the massager can work stably even on a smooth surface.

As shown in FIGS. 1-7, the handle 10 is provided as an angle-adjustable handle, and the handle 10 is connected to both sides of the clamping ring 4, which provides a more flexible usage angle and enhances the comfort and adaptability during use.

### Embodiment 2

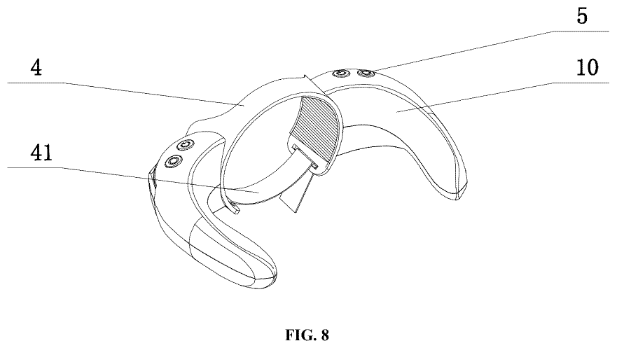

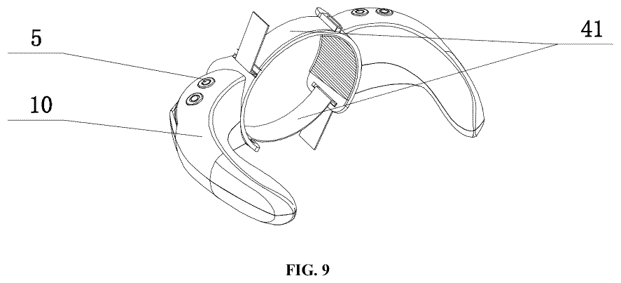

As shown in FIGS. 8-9, the difference between the second embodiment and first embodiment is that tightening strips 41 can be provided on both upper and lower ends of the clamping ring 4, and the tightening strips 41 may be any one of Velcro, ribbons and tightening belts. The handle 10 can accommodate the battery 6, the charging base 7 and the PCB board 8, and is suitable for massagers of different sizes.

### Embodiment 3

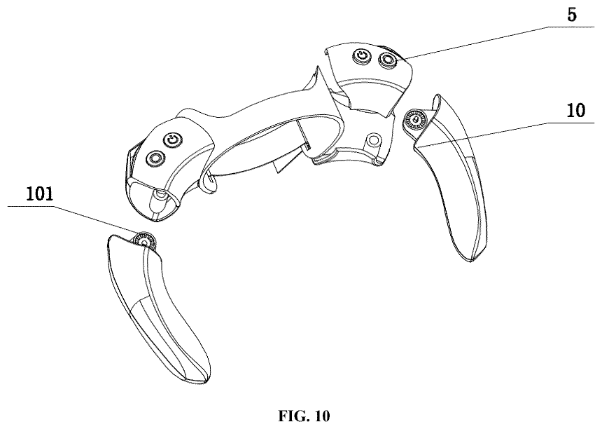

As shown in FIGS. 10-12, the difference between the third embodiment and first embodiment is that a movable bearing 101 can be provided inside the handle 10, and the handle 10 can be adjusted in lateral direction through the movable bearing 101, thereby realizing more steering settings of the handle 10, meeting the higher adjustment requirements of the user.

The working principle of the present invention is: The upper shell 2 is connected to the upper part of the lower shell 3 to form a handle 10, the battery 6, the charging base 7 and the PCB board 8 are installed in the handle 10, the array buttons 5 are provided on the surface of the upper shell 2, the anti-skid pad 9 is provided on the inner side of the clamping ring 4, and tightening strip 41 is connected to the two ends of the clamping ring 4. The battery 6 and the charging base 7 provide power for the massager, the PCB board 8 is used to control the operation mode of the massager, the buttons 5 are provided on the surface of the upper shell 2 for easy operation, and the anti-skid pad 9 is provided in high friction anti-skid material, in order to ensure that the massager can work stably even on a smooth surface.

In the present invention, unless otherwise stated, it should be noted that the terms “provided” and “connected” should be understood broadly. For example, “connected” could be fixed connection, detachable connection, integral connection, mechanical connection, electrical connection, direct connection, indirect connection through the intermediate structure, or internal connection between two elements.

Hereinafter, embodiments of the present invention have been described in detail with reference to the accompanying drawings. While the description above refers to the particular embodiments of the present invention, it will be understood that many modifications may be made without departing from the spirit thereof. Any equivalent replacement or modification would fall within the protection scope of the present invention.

What is claimed is:

1. A massager handle, comprising a clamping handle (1) on an outside portion of a massager, wherein the clamping handle (1) comprises an upper shell (2), a lower shell (3), a clamping ring (4), a button (5), a battery (6), a charging base (7), a PCB board (8), and an anti-skid pad (9); said lower shell (3) is provided on both sides of the clamping ring (4), the upper shell (2) is connected to the upper part of the lower shell (3) to form a handle (10); the battery (6), the charging base (7) and the PCB board (8) are installed in the handle (10), the array buttons (5) are provided on the handle (10), the anti-skid pad (9) is provided on the inner side of the clamping ring (4), and the clamping ring (4) is connected with a tightening strip (41).

2. The massager handle according to claim 1, wherein the upper shell (2) and the lower shell (3) are made of plastic or silicone.

3. The massager handle according to claim 1, wherein the battery (6), charging base (7), and PCB board (8) are control connected to the massager.

4. The massager handle according to claim 1, wherein the battery (6) is any one of a rechargeable battery, a lithium battery or a dry cell.

5. The massager handle according to claim 1, wherein the charging base (7) is provided as TPC interface, and the charging base (7) is connected with a charging electronic connection line.

6. The massager handle according to claim 1, wherein the PCB board (8) is made of FR4 material.

7. The massager handle according to claim 1, wherein the anti-skid pad (9) is made of a high-friction anti-skid material, and anti-skid patterns are provided on one end of the anti-skid pad (9) close to the massager.

8. The massager handle according to claim 1, wherein the handle (10) is provided as an angle-adjustable handle, the handle (10) is connected to both sides of the clamping ring (4), and the handle (10) is can be provided as remote control handle controlled by infrared remote control or Bluetooth control.

9. The massager handle according to claim 1, wherein the tightening strips (41) can be provided on both upper and lower ends of the clamping ring (4), and the tightening strips (41) can be any one of Velcro, ribbons and tightening belts; the interior of the handle (10) can be compatible with the battery (6), the charging base (7) and PCB board (8), and can be suitable for massagers of different sizes.

10. The massager handle according to claim 1, wherein a movable bearing (101) can be provided inside the handle (10), and the handle (10) can be adjusted in lateral direction through the movable bearing (101).
